(19) United States
(12) Patent Application Publication
(10) Pub. No.: US 2017/0222773 A1
(43) Pub. Date: Aug. 3, 2017

(54) Inter-Cell Interference Coordination in Heterogeneous Networks

(71) Applicant: Nokia Solutions and Networks Oy, Espoo (FI)

(72) Inventors: Moushumi SEN, Bangalore (IN); Suresh KALYANASUNDARAM, Bangalore (IN); Prakhar V NASHINE, Bangalore (IN)

(21) Appl. No.: 15/502,567

(22) PCT Filed: Aug. 11, 2014
(86) PCT No.: PCT/EP2014/067173

§ 371 Date: Feb. 8, 2017

(51) Int. Cl. H04L 5/00; H04W 72/12; H04W 24/10

(52) U.S. Cl. CPC H04L 5/0032; H04W 24/10; H04W 72/1231; H04L 5/0073; H04W 84/045

(57) ABSTRACT

There are provided measures for inter-cell interference coordination in heterogeneous networks. Such measures exemplarily include determining a strongest interfering macro cell access node, said strongest interfering macro cell access node operating in time based subframes, wherein said subframes include almost blank transmission subframes during which said strongest interfering macro cell access node is muted and active transmission subframes during which said strongest interfering macro cell access node is transmitting, reporting said strongest interfering macro cell access node, and receiving a transmission in a subframe, wherein a control parameter of said transmission is set based on whether said subframe corresponds to an almost blank transmission subframe of said strongest interfering macro cell access node or to an active transmission subframe of said strongest interfering macro cell access node.

### FIELD

The present invention relates to inter-cell interference coordination in heterogeneous networks. More specifically, the present invention exemplarily relates to measures (including methods, apparatuses and computer program products) for realizing inter-cell interference coordination in heterogeneous networks.

### BACKGROUND

The present specification generally relates to heterogeneous network (HetNet) deployments in Long Term Evolution (LTE) systems.

HetNet deployments in LTE systems consist of a mix of high powered Macro evolved NodeBs (eNodeB, eNB) along with one or more low powered Pico eNBs within the coverage area of each Macro cell.

In co-channel deployments, the two types of eNBs share the same frequency band, and the performance of the users in Pico cells might be severely impaired by interference from its neighboring high powered Macro eNB, specifically for those users which are located in the range-extended area of a Pico cell.

Enhanced Inter-Cell Interference Coordination (eICIC) allows the Macro eNB to mute some of its subframes (called Almost Blank Subframes (ABS)) such that there is no physical downlink shared channel (PDSCH) transmission during these subframes.

Users associated with the Pico eNB experience reduced downlink interference during these subframes when the overlaying Macro eNB is muted.

According to one option in relation to eICIC, a centralized ABS proportion may be applied. According to this, a network wide optimum value of muting ratio is used that allows all Macro eNBs to align their ABS subframes to be aligned for maximum benefit to Pico users.

In doing so, the muting ratio can be based on the overall load imbalance between the high powered Macro cells and the low powered Pico cells in the network.

Consequently, cell-edge Pico user equipments (UE) are able to receive downlink transmission with relatively higher signal to interference and noise ratio (SINR), thereby improving Pico cell-edge UE performance during ABS subframes.

According to another option in relation to eICIC, localized ABS proportions may be applied. According to this, each Macro cell sets its own muting ratio independently of its neighboring Macro cells.

Neighboring Macro eNBs may have different muting ratios, giving rise to situations when a Macro eNB has PDSCH transmissions when its neighboring Macro cell (with a higher muting ratio) is muted.

In particular, according to current implementations, a single link adaptation loop for Macro UEs (i.e. UEs served by a Macro cell, in particular, served by a Macro eNB serving a Macro cell) is enabled for channel estimation purposes. In heterogeneous networks, this is adequate when a single network wide muting ratio is used by all Macro eNBs.

In practical situations, traffic patterns and consequently the load imbalance between neighboring (Pico and/or Macro) cells may change substantially over time and spatially across cells, making it necessary to adapt the ABS proportion.

Dynamically deriving a single ABS proportion requires network wide coordination amongst all Macro cells in the network, which is not always practical.

Accordingly, a practical approach (distributed ABS adaptation) was derived whereby local load information (that of a Macro cell and its subtending Pico cells) is used to arrive at an optimal muting ratio for each Macro eNB independent of its neighboring cells.

Neighboring Macro eNBs are thus likely to adapt to different muting ratios in such cases.

Cell-edge Macro UEs may experience significantly different levels of interference between their downlink transmissions on subframes when their neighboring Macro eNBs are muted and those on subframes when their neighboring Macro eNBs are not muted. Such a case may happen if an interfering Macro eNB has a higher muting ratio than the serving cell of the Macro UE. Such a case may also happen even when an interfering Macro eNB has the same or lower muting ratio but when the ABS muting patterns of the two neighboring Macro cells are not time-aligned.

A single link adaptation loop for these Macro UEs might result in inaccurate channel estimation due to the wide variation in interference experienced by the UE. This in turn can have an effect on both PDSCH and physical downlink control channel (PDCCH) transmissions.

For example, a modulation and coding scheme (MCS) used for data transmissions to the UE may be too conservative when one or more of the UE's neighboring Macro eNBs are muted and too aggressive when they are not muted. Further, a number of control channel elements (CCE) required for PDCCH transmissions to the UE may similarly give rise to inefficiencies as it is also based on inaccurate signal to noise ratio (SNR) estimation.

According to a further current implementation, two independent link adaptation loops for Pico UEs are enabled in order to better estimate the channel state when the Pico eNB's own Macro eNB is (1.) muted and is (2.) transmitting.

As discussed with respect to the earlier implementations, the case is considered when neighboring Macro eNBs adapt to different muting ratios during distributed ABS adaptation.

In such case, Macro eNBs whose downlink transmission result in strong interference to a Pico UE located close to the boundary between two Macro eNBs may be one or more neighboring Macro eNBs rather than its own overlaying Macro eNB.

If these neighboring Macro eNBs have a different muting ratio than that corresponding to the Pico eNB's overlaying Macro eNB, then the existing channel estimation algorithm that is synchronized to its overlaying Macro eNB's subframe status will give an inaccurate estimation of the UEs SINR, both during ABS and non-ABS subframes.

Hence, the problem arises that the above mentioned implementations of eICIC in heterogeneous networks do not take into account the inaccuracies that arise in channel estimation of its Pico and Macro UEs when the proportions of muted subframes are different amongst neighboring Macro eNBs. Such a situation may arise when each Macro eNB is required to adapt its muting ratio that is adapted to the local information, e.g. the load differential (if any) existing between the Macro eNB and the Pico eNBs within its coverage area. In such cases, the performance of the Pico UEs that lie in the boundary of Macro and Pico coverage areas is severely affected. In such cases, also the performance of the Macro UEs that lie in the boundary of Macro coverage areas may be severely affected.

Hence, there is a need to provide for inter-cell interference coordination in heterogeneous networks.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising determining a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting, reporting said strongest interfering macro cell access node, and receiving a transmission in a subframe, wherein a control parameter of said transmission is set based on whether said subframe corresponds to an almost blank transmission subframe of said strongest interfering macro cell access node or to an active transmission subframe of said strongest interfering macro cell access node.

According to an exemplary aspect of the present invention, there is provided a method comprising determining a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting, checking whether there are almost blank transmission subframes of said strongest interfering macro cell access node and active transmission subframes of said strongest interfering macro cell access node corresponding to active transmission subframes of a serving access node, wherein if there are almost blank transmission subframes of said strongest interfering macro cell access node and active transmission subframes of said strongest interfering macro cell access node corresponding to active transmission subframes of said serving access node, said method further comprises reporting said strongest interfering macro cell access node, and receiving a transmission in a subframe, wherein a control parameter of said transmission is set based on whether said subframe corresponds to an almost blank transmission subframe of said strongest interfering macro cell access node or to an active transmission subframe of said strongest interfering macro cell access node.

According to an exemplary aspect of the present invention, there is provided a method comprising obtaining a strongest interfering macro cell access node of a terminal, said strongest interfering macro cell access node operating in time based subframes, wherein said subframes comprise almost blank transmission subframes during which said strongest interfering macro cell access node is muted and active transmission subframes during which said strongest interfering macro cell access node is transmitting, and setting a control parameter of a transmission scheduled for a subframe based on whether said subframe corresponds to an almost blank transmission subframe of said strongest interfering macro cell access node or to an active transmission subframe of said strongest interfering macro cell access node.

According to an exemplary aspect of the present invention, there is provided an apparatus comprising determining means configured to determine a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting, reporting means configured to report said strongest interfering macro cell access node, and receiving means configured to receive a transmission in a subframe, wherein a control parameter of said transmission is set based on whether said subframe corresponds to an almost blank transmission subframe of said strongest interfering macro cell access node or to an active transmission subframe of said strongest interfering macro cell access node.

According to an exemplary aspect of the present invention, there is provided an apparatus comprising determining means configured to determine a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting, checking means configured to check whether there are almost blank transmission subframes of said strongest interfering macro cell access node and active transmission subframes of said strongest interfering macro cell access node corresponding to active transmission subframes of a serving access node, reporting means, and receiving means, wherein if there are almost blank transmission subframes of said strongest interfering macro cell access node and active transmission subframes of said strongest interfering macro cell access node corresponding to active transmission subframes of said serving access node, said reporting means is configured to report said strongest interfering macro cell access node, and said receiving means is configured to receive a transmission in a subframe, wherein a control parameter of said transmission is set based on whether said subframe corresponds to an almost blank transmission subframe of said strongest interfering macro cell access node or to an active transmission subframe of said strongest interfering macro cell access node.

According to an exemplary aspect of the present invention, there is provided an apparatus comprising obtaining means configured to obtain a strongest interfering macro cell access node of a terminal, said strongest interfering macro cell access node operating in time based subframes, wherein said subframes comprise almost blank transmission subframes during which said strongest interfering macro cell access node is muted and active transmission subframes during which said strongest interfering macro cell access node is transmitting, and setting means configured to set a control parameter of a transmission scheduled for a subframe based on whether said subframe corresponds to an almost blank transmission subframe of said strongest interfering macro cell access node or to an active transmission subframe of said strongest interfering macro cell access node.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient handling of inter-cell interferences and consideration of almost blank subframes of neighboring cells in transmission control to thereby solve at least part of the problems and drawbacks identified in relation to the prior art.

By way of exemplary embodiments of the present invention, there is provided inter-cell interference coordination in heterogeneous networks.

More specifically, by way of exemplary embodiments of the present invention, there are provided measures and mechanisms for realizing inter-cell interference coordination in heterogeneous networks.

Thus, improvement is achieved by methods, apparatuses and computer program products enabling/realizing inter-cell interference coordination in heterogeneous networks.

### BRIEF DESCRIPTION OF THE DRAWINGS

In the following, the present invention will be described in greater detail by way of non-limiting examples with reference to the accompanying drawings, in which

FIG. 1 is a block diagram illustrating an apparatus according to exemplary embodiments of the present invention,

FIG. 2 is a block diagram illustrating an apparatus according to exemplary embodiments of the present invention,

FIG. 3 is a block diagram illustrating an apparatus according to exemplary embodiments of the present invention,

FIG. 4 is a block diagram illustrating an apparatus according to exemplary embodiments of the present invention,

FIG. 5 is a block diagram illustrating an apparatus according to exemplary embodiments of the present invention,

FIG. 6 is a block diagram illustrating an apparatus according to exemplary embodiments of the present invention,

FIG. 7 is a schematic diagram of a procedure according to exemplary embodiments of the present invention,

FIG. 8 is a schematic diagram of a procedure according to exemplary embodiments of the present invention,

FIG. 9 is a schematic diagram of a procedure according to exemplary embodiments of the present invention,

FIG. 10 shows a schematic diagram of an example of a system environment according to exemplary embodiments of the present invention,

FIG. 11 shows a schematic diagram of an example of a system environment according to exemplary embodiments of the present invention, and

FIG. 12 is a block diagram alternatively illustrating apparatuses according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. As such, the description of exemplary embodiments given herein specifically refers to terminology which is directly related thereto. Such terminology is only used in the context of the presented non-limiting examples, and does naturally not limit the invention in any way. Rather, any other communication or communication related system deployment, etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) inter-cell interference coordination in heterogeneous networks.

Hence, in view of the implementations mentioned earlier above, according to exemplary embodiments of the present invention, a better channel estimation is provided which takes into account the mentioned two different interference levels.

Further, in view of the implementation mentioned later above, according to exemplary embodiments of the present invention, a better channel estimation is provided which takes into account the subframe status (ABS or non-ABS) of each Pico UE's strongest Macro interferer.

According to exemplary embodiments of the present invention, problems are addressed that are raised during channel estimation when muting ratios of neighboring Macro eNBs are out of synchronization with each other.

In particular, according to exemplary embodiments of the present invention such scenario is addressed by providing a simple and effective solution as follows.

Namely, an enhanced SINR estimation for inter-cell interference coordination in HetNets is provided.

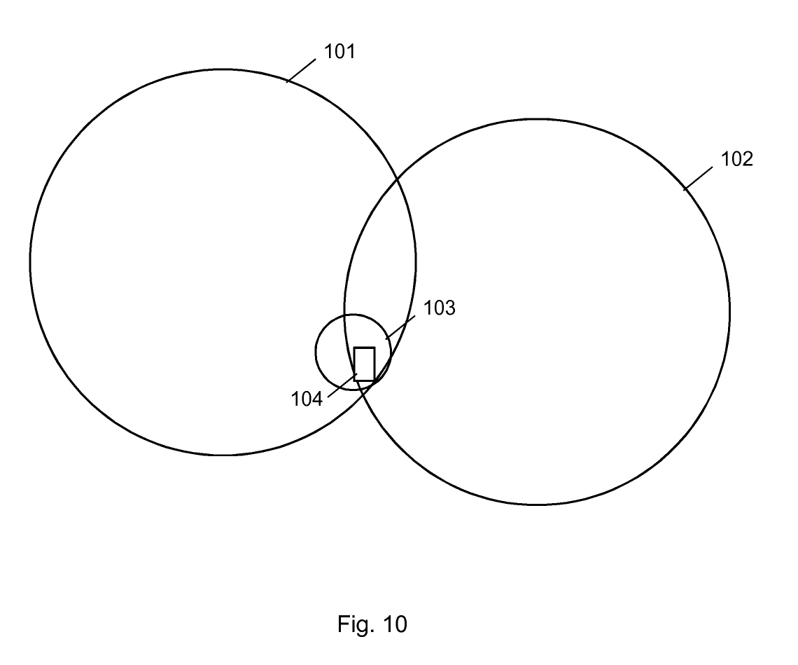

FIG. 10 shows a schematic diagram of an example of a system environment according to exemplary embodiments of the present invention.

As shown in FIG. 10, two neighboring Macro cells 101 and 102 are overlapping and correspondingly interfering with each other in particular regions. Furthermore, a Pico cell 103 covered by Macro cell 101 is arranged at the border of Macro cell 101. In particular regions, the Pico cell 103 is interfered by each of Macro cells 101 and 102 with certain intensities.

A terminal (e.g. UE) 104 is arranged within the coverage area of Pico cell 103 and may be served by Pico cell 103. Such terminal may be named Pico UE 104. The reception of UE 104 regarding Pico cell 103 may be interfered by Macro cells 101 and 102. Such interfering Macro cell and the Macro access node serving such interfering Macro cell, respectively, may be named Macro interferer.

According to exemplary embodiments of the present invention, a method and an apparatus are provided to improve channel estimation for Pico UEs.

Namely, according to exemplary embodiments of the present invention, in short, two independent PDSCH and PDCCH link adaptation loops are used for Pico UEs which depend on the subframe status (ABS or non-ABS) of the UE's strongest macro interferer.

In this relation, subframe status means whether the respective subframe is an ABS subframe for a considered access node or whether the respective subframe is a non-ABS subframe for the considered access node.

For each Pico UE, its strongest Macro interferer is determined using reference signal received power (RSRP) measurements. This strongest Macro interferer may not necessarily be the same as the Pico UE's overlaying Macro eNB.

Optionally, each Pico UE may report 2 channel quality indicator (CQI) values, namely an ABS CQI for a subframe when the Pico UE's strongest macro interferer is muted, and a non-ABS CQI for a subframe when the Pico UE's strongest macro interferer is transmitting.

Further, two separate and independent PDSCH link adaptations for this Pico UE corresponding to the subframe status of its strongest Macro interferer may be performed, namely for the subframe status that the Pico UE's top interfering Macro eNB is muted and for the subframe status that the Pico UE's top interfering Macro eNB is not muted.

During PDSCH scheduling of the Pico UE in any given subframe, an MCS to be used for data transmission may be selected based on the estimated SINR corresponding to the subframe status (i.e., ABS or non-ABS) of the Pico UE's strongest Macro interferer.

Furthermore, during PDSCH scheduling of the Pico UE in any given subframe, the scheduling metric itself may be chosen based on the different SINRs corresponding to the subframe status (i.e., ABS or non-ABS) of the Pico UE's strongest Macro interferer. Typically, a proportional fairness metric is used, which is the estimated instantaneous rate of the UE in the given subframe divided by an average throughput of the UE. For the instantaneous rate of the UE, an appropriate rate may be used. That is, the appropriate rate corresponding to the subframe status of the Pico UE's strongest Macro interferer may be used for scheduling purposes, which typically uses the UE's estimated SINR. That is, in general terms, The UE that is scheduled may be influenced by whether the subframe is an ABS subframe or not.

The scheduling metric may be basically dependent on the estimated SINR. Accordingly, the amount by which the scheduling metric is set higher may depend on the amount by which the estimated SINR is larger on ABS subframes compared to the estimated SINR on non-ABS subframes. Typically, the scheduling metric is (estimated rate)/(throughput received by UE so far). Estimated rate may basically be larger in the ABS subframe when compared to the non-ABS subframe.

Further, two separate and independent PDCCH link adaptations for this Pico UE corresponding to the subframe status of the Pico UE's top Macro interferer may be performed.

During control channel scheduling of the Pico UE in any given subframe, the number of CCEs required for the Pico UE's PDCCH transmission may be selected based on the estimated SINR that corresponds to the subframe status (i.e., ABS or non-ABS) of the Pico UE's strongest Macro interferer.

Furthermore, during control channel scheduling of the Pico UE in any given subframe, the PDCCH transmit power may be adapted based on whether the subframe is an ABS subframe or not for the UE's strongest interferer.

Considering both options during control channel scheduling, either the number of CCEs to be used for the UE is set lower (are fewer) in an ABS subframe for the UE's strongest interferer, or the transmit power is set lower (is reduced) for the same number of CCEs, or a combination of both options may be applied.

That is, during PDSCH scheduling and control channel scheduling a control parameter may be set which can be seen as a transmission parameter and/or a scheduling parameter related to the scheduling and transmission.

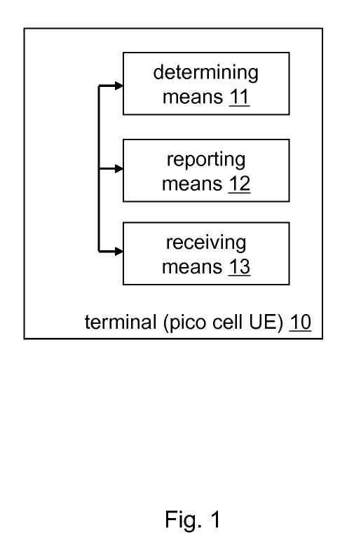

Those exemplary embodiments of the present invention are described below in more general terms referring to FIGS. 1, 2, 5, 6, 7 and 9.

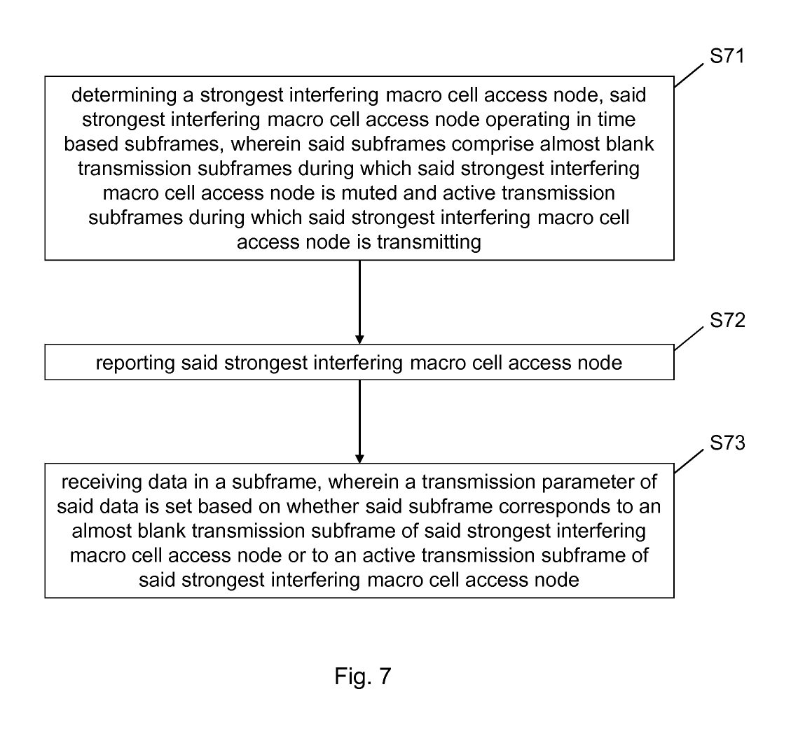

FIG. 1 is a block diagram illustrating an apparatus according to exemplary embodiments of the present invention. The apparatus may be a terminal 10 such as a UE (in particular a Pico cell UE) comprising a determining means 11, a reporting means 12, and a receiving means 13. The determining means 11 determines a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting. The reporting means 12 reports said strongest interfering macro cell access node. The receiving means 13 receives a transmission in a subframe, wherein a control parameter of said transmission is set based on whether said subframe corresponds to an almost blank transmission subframe of said strongest interfering macro cell access node or to an active transmission subframe of said strongest interfering macro cell access node. FIG. 7 is a schematic diagram of a procedure according to exemplary embodiments of the present invention. The apparatus according to FIG. 1 may perform the method of FIG. 7 but is not limited to this method. The method of FIG. 7 may be performed by the apparatus of FIG. 1 but is not limited to being performed by this apparatus.

As shown in FIG. 7, a procedure according to exemplary embodiments of the present invention comprises an operation of determining (S71) a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting, an operation of reporting (S72) said strongest interfering macro cell access node, and an operation of receiving (S73) a transmission in a subframe, wherein a control parameter of said transmission is set based on whether said subframe corresponds to an almost blank transmission subframe of said strongest interfering macro cell access node or to an active transmission subframe of said strongest interfering macro cell access node.

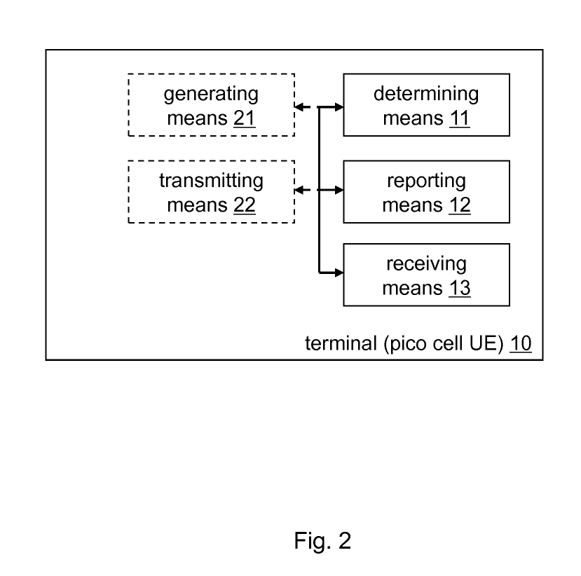

FIG. 2 is a block diagram illustrating an apparatus according to exemplary embodiments of the present invention. In particular, FIG. 2 illustrates a variation of the apparatus shown in FIG. 1. The apparatus according to FIG. 2 may thus further comprise generating means 21 and transmitting means 22.

According to a variation of the procedure shown in FIG. 7, exemplary additional operations are given, which are inherently independent from each other as such. According to such variation, an exemplary method according to exemplary embodiments of the present invention may comprise an operation of generating a first channel quality indicator indicative of a reception quality regarding a serving access node during an almost blank transmission subframe of said strongest interfering macro cell access node, an operation of generating a second channel quality indicator indicative of a reception quality regarding said serving access node during an active transmission subframe of said strongest interfering macro cell access node, and an operation of transmitting said first and second channel quality indicators.

According to a variation of the procedure shown in FIG. 7 according to exemplary embodiments of the present invention, said control parameter is set based on said first channel quality indicator, if said subframe corresponds to an almost blank transmission subframe of said strongest interfering macro cell access node, and said control parameter is set based on said second channel quality indicator, if said subframe corresponds to an active transmission subframe of said strongest interfering macro cell access node.

According to a further variation of the procedure shown in FIG. 7 according to exemplary embodiments of the present invention, said transmission comprises a physical downlink shared channel, said control parameter is a modulation and coding scheme, and said modulation and coding scheme is set higher if said subframe corresponds to an almost blank transmission subframe of said strongest interfering macro cell access node than if said subframe corresponds to an active transmission subframe of said strongest interfering macro cell access node.

Alternatively, said transmission comprises the physical downlink shared channel, said control parameter is a scheduling metric, and said scheduling metric is set higher if said subframe corresponds to an almost blank transmission subframe of said strongest interfering macro cell access node than if said subframe corresponds to an active transmission subframe of said strongest interfering macro cell access node.

According to a still further variation of the procedure shown in FIG. 7 according to exemplary embodiments of the present invention, said transmission comprises a physical downlink control channel, said control parameter is a number of used control channel elements, and said number of used control channel elements is set lower if said subframe corresponds to an almost blank transmission subframe of said strongest interfering macro cell access node than if said subframe corresponds to an active transmission subframe of said strongest interfering macro cell access node.

Alternatively, said transmission comprises the physical downlink control channel, said control parameter is a transmission power, and said a transmission power is set lower if said subframe corresponds to an almost blank transmission subframe of said strongest interfering macro cell access node than if said subframe corresponds to an active transmission subframe of said strongest interfering macro cell access node.

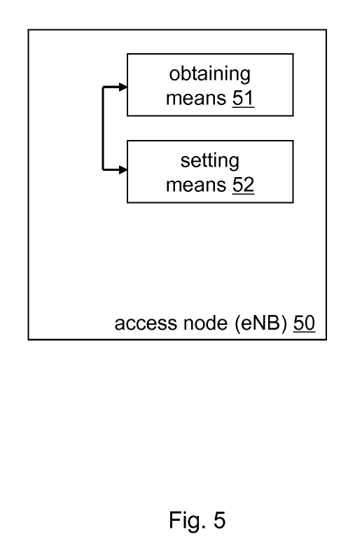

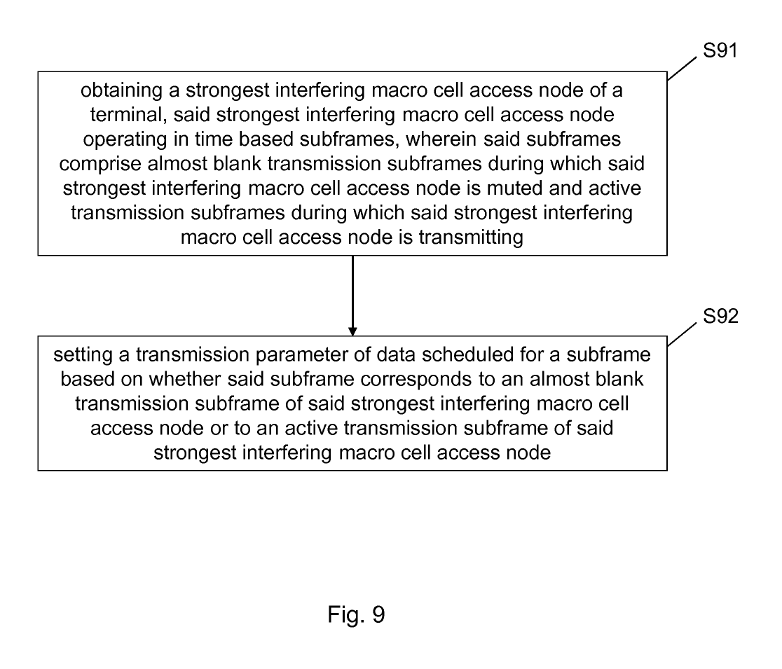

FIG. 5 is a block diagram illustrating an apparatus according to exemplary embodiments of the present invention. The apparatus may be an access node 50 such as an eNB (Pico cell eNB, Macro cell eNB) comprising a obtaining means 51 and a setting means 52. The obtaining means 51 obtains a strongest interfering macro cell access node of a terminal, said strongest interfering macro cell access node operating in time based subframes, wherein said subframes comprise almost blank transmission subframes during which said strongest interfering macro cell access node is muted and active transmission subframes during which said strongest interfering macro cell access node is transmitting. The setting means 52 sets a control parameter of a transmission scheduled for a subframe based on whether said subframe corresponds to an almost blank transmission subframe of said strongest interfering macro cell access node or to an active transmission subframe of said strongest interfering macro cell access node. FIG. 9 is a schematic diagram of a procedure according to exemplary embodiments of the present invention. The apparatus according to FIG. 5 may perform the method of FIG. 9 but is not limited to this method. The method of FIG. 9 may be performed by the apparatus of FIG. 5 but is not limited to being performed by this apparatus.

As shown in FIG. 9, a procedure according to exemplary embodiments of the present invention comprises an operation of obtaining (S91) a strongest interfering macro cell access node of a terminal, said strongest interfering macro cell access node operating in time based subframes, wherein said subframes comprise almost blank transmission subframes during which said strongest interfering macro cell access node is muted and active transmission subframes during which said strongest interfering macro cell access node is transmitting, and an operation of setting (S92) a control parameter of a transmission scheduled for a subframe based on whether said subframe corresponds to an almost blank transmission subframe of said strongest interfering macro cell access node or to an active transmission subframe of said strongest interfering macro cell access node.

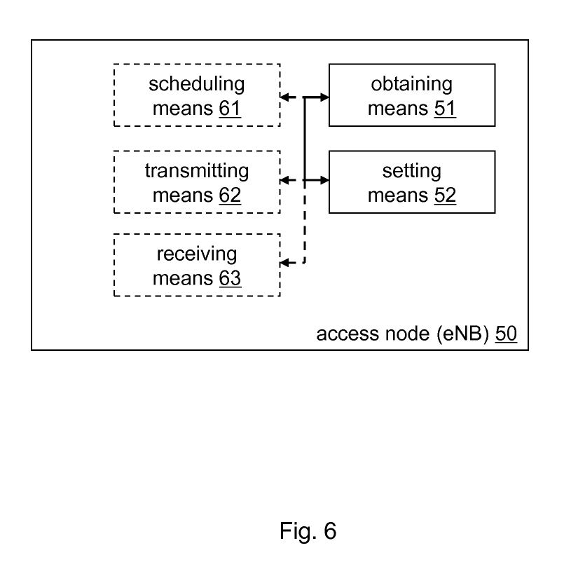

FIG. 6 is a block diagram illustrating an apparatus according to exemplary embodiments of the present invention. In particular, FIG. 6 illustrates a variation of the apparatus shown in FIG. 5. The apparatus according to FIG. 6 may thus further comprise scheduling means 61, transmitting means 62, and receiving means 63.

According to a variation of the procedure shown in FIG. 9, exemplary additional operations are given, which are inherently independent from each other as such. According to such variation, an exemplary method according to exemplary embodiments of the present invention may comprise an operation of scheduling said transmission for said subframe using said control parameter, and an operation of transmitting said transmission in said subframe using said control parameter.

According to a variation of the procedure shown in FIG. 9, exemplary additional operations are given, which are inherently independent from each other as such. According to such variation, an exemplary method according to exemplary embodiments of the present invention may comprise an operation of receiving a first channel quality indicator indicative of a reception quality of said terminal regarding a serving access node during an almost blank transmission subframe of said strongest interfering macro cell access node and a second channel quality indicator indicative of a reception quality of said terminal regarding said serving access node during an active transmission subframe of said strongest interfering macro cell access node.

According to a variation of the procedure shown in FIG. 9 according to exemplary embodiments of the present invention, said control parameter is set based on said first channel quality indicator, if said subframe corresponds to an almost blank transmission subframe of said strongest interfering macro cell access node, and said control parameter is set based on said second channel quality indicator, if said subframe corresponds to an active transmission subframe of said strongest interfering macro cell access node.

According to a further variation of the procedure shown in FIG. 9 according to exemplary embodiments of the present invention, said transmission comprises a physical downlink shared channel, said control parameter is a modulation and coding scheme, and said modulation and coding scheme is set higher if said subframe corresponds to an almost blank transmission subframe of said strongest interfering macro cell access node than if said subframe corresponds to an active transmission subframe of said strongest interfering macro cell access node.

Alternatively, said transmission comprises the physical downlink shared channel, said control parameter is a scheduling metric, and said scheduling metric is set higher if said subframe corresponds to an almost blank transmission subframe of said strongest interfering macro cell access node than if said subframe corresponds to an active transmission subframe of said strongest interfering macro cell access node.

According to a still further variation of the procedure shown in FIG. 9 according to exemplary embodiments of the present invention, said transmission comprises a physical downlink control channel, said control parameter is a number of used control channel elements, and said number of used control channel elements is set lower if said subframe corresponds to an almost blank transmission subframe of said strongest interfering macro cell access node than if said subframe corresponds to an active transmission subframe of said strongest interfering macro cell access node.

Alternatively, said transmission comprises the physical downlink control channel, said control parameter is a transmission power, and said transmission power is set lower if said subframe corresponds to an almost blank transmission subframe of said strongest interfering macro cell access node than if said subframe corresponds to an active transmission subframe of said strongest interfering macro cell access node.

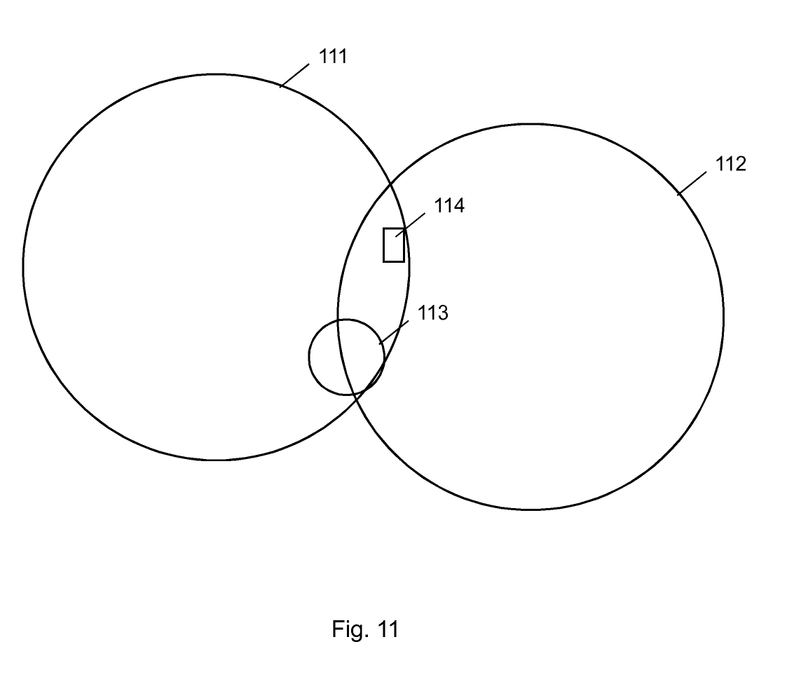

FIG. 11 shows a schematic diagram of an example of a system environment according to exemplary embodiments of the present invention.

As shown in FIG. 11, two neighboring Macro cells 111 and 112 are overlapping and correspondingly interfering with each other in particular regions. Furthermore, a Pico cell 113 covered by Macro cell 111 is arranged at the border of Macro cell 111. In particular regions, the Pico cell 113 is interfered by each of Macro cells 111 and 112 with certain intensities.

A terminal (e.g. UE) 114 is arranged within the coverage area of Macro cells 111 and 112 and may be served by Macro cell 111. Such terminal may be named Macro UE 114. The reception of UE 114 regarding Macro cell 111 may be interfered by Macro cell 112. Such interfering Macro cell and the Macro access node serving such interfering Macro cell, respectively, may be named Macro interferer.

According to exemplary embodiments of the present invention, a method and an apparatus are provided to improve channel estimation for Macro UEs.

Namely, according to exemplary embodiments of the present invention, in short, two independent PDSCH and PDCCH link adaptations for Macro UEs are used which depend on the subframe status (ABS or non-ABS) of the UE's strongest macro interferer.

Also in this relation, subframe status means whether the respective subframe is an ABS subframe for a considered access node or whether the respective subframe is a non-ABS subframe for the considered access node.

For each Macro UE determine the Macro UE's strongest Macro interferer is determined using RSRP measurements.

If the ABS ratio of this top interfering Macro eNB (i.e. the Macro UE's strongest Macro interferer) is higher than that of the serving cell (i.e. that of the Macro eNB serving the UE), or alternatively, if the ABS ratio of the strongest interferer is equal to or smaller than the ABS ratio of the serving cell but the ABS patterns of the two cells (cell of the strongest interferer and serving cell) are not aligned (not matched, unsynchronized) with each other, then the following is done. In particular, the following is done if there are both ABS and non-ABS subframes of the strongest interferer aligned with non-ABS subframes of the serving cell.

Optionally each Macro UE may report two CQI values during non-ABS subframes of its serving cell, namely an ABS CQI for a subframe when the Macro UE's strongest macro interferer is muted, and a Non-ABS CQI for a subframe when the Macro UE's strongest macro interferer is transmitting.

Further, two separate and independent PDSCH link adaptations for this UE may be performed that corresponds to the subframe status of the Macro UE's top macro interferer, namely for the subframe status that only the Macro UE's interfering Macro eNB is muted and for the subframe status that both the Macro UE's serving cell and the Macro UE's strongest Macro interferer are transmitting.

During PDSCH scheduling of the Macro UE in any given subframe, an MCS may be selected based on the estimated SINR corresponding to the subframe status (i.e., ABS or non-ABS) of the Macro UE's strongest Macro interferer.

The estimated/compensated SINR value and consequently the scheduled MCS of the Macro UE in subframes when the Macro UE's strongest Macro interferer is muted may be significantly higher as compared to that in subframes when it is not muted.

Furthermore, during PDSCH scheduling of the Macro UE in any given subframe, the scheduling metric itself may be chosen based on the different SINRs corresponding to the subframe status (i.e., ABS or non-ABS) of the Macro UE's strongest Macro interferer. Typically, a proportional fairness metric is used, which is the estimated instantaneous rate of the UE in the given subframe divided by an average throughput of the UE. For the instantaneous rate of the UE, an appropriate rate may be used. That is, the appropriate rate corresponding to the subframe status of the Macro UE's strongest Macro interferer may be used for scheduling purposes, which typically uses the UE's estimated SINR. That is, in general terms, the UE that is scheduled may be influenced by whether the subframe is an ABS subframe or not.

Correspondingly, the likelihood of a UE getting scheduled when its strongest interferer is muted is larger compared to the case when the strongest interferer is transmitting.

The scheduling metric may be basically dependent on the estimated SINR. Accordingly, the amount by which the scheduling metric is set higher may depend on the amount by which the estimated SINR is larger on ABS subframes compared to the estimated SINR on non-ABS subframes. Typically, the scheduling metric is (estimated rate)/(throughput received by UE so far). Estimated rate may basically be larger in the ABS subframe when compared to the non-ABS subframe.

Further, two separate and independent PDCCH link adaptations for this UE may be performed corresponding to the subframe status of the Macro UE's top macro interferer.

During control channel scheduling of the Macro UE in any given subframe, the number of CCEs required for PDCCH transmission may be selected based on the estimated SINR that corresponds to the subframe status (i.e., ABS or non-ABS) of the Macro UE's top Macro interferer.

Furthermore, during control channel scheduling of the Macro UE in any given subframe, the PDCCH transmit power may be adapted based on whether the subframe is an ABS subframe or not for the UE's strongest interferer.

Considering both options during control channel scheduling, either the number of CCEs to be used for the UE is set lower (are fewer) in an ABS subframe for the UE's strongest interferer, or the transmit power is set lower (is reduced) for the same number of CCEs, or a combination of both options may be applied.

That is, during PDSCH scheduling and control channel scheduling a control parameter may be set which can be seen as a transmission parameter and/or a scheduling parameter related to the scheduling and transmission.

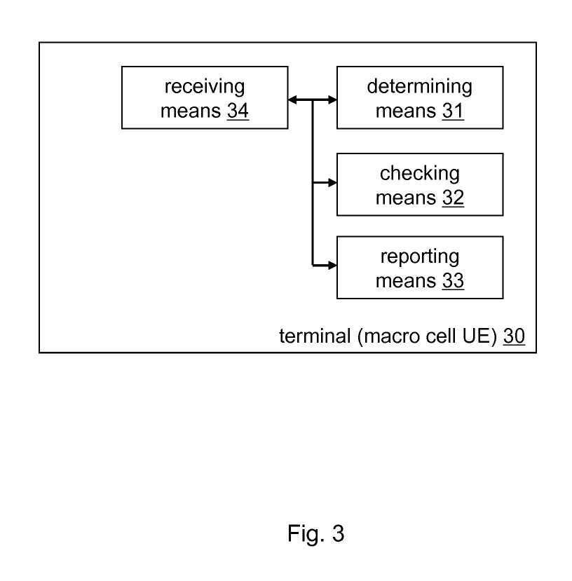

Those exemplary embodiments of the present invention are described below in more general terms referring to FIGS. 3, 4 and 8.

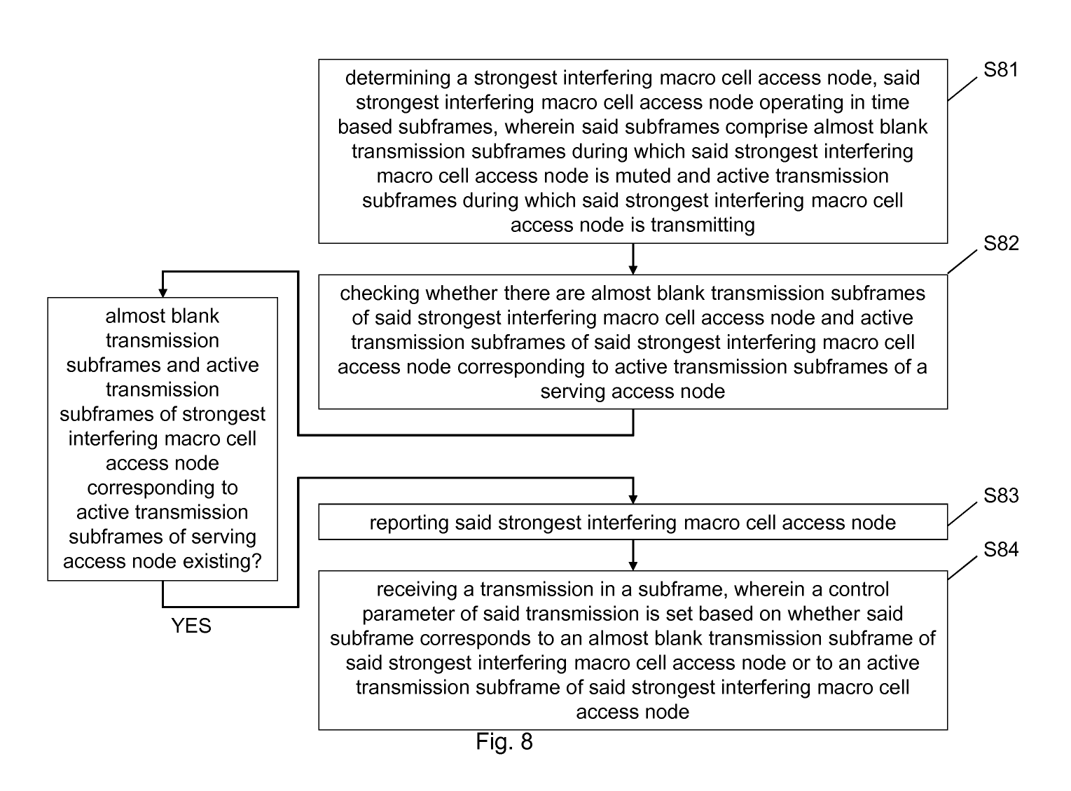

FIG. 3 is a block diagram illustrating an apparatus according to exemplary embodiments of the present invention. The apparatus may be a terminal 30 such as a UE (in particular a Macro cell UE) comprising a determining means 31, a checking means 32, a reporting means 33, and a receiving means 34. The determining means 31 determines a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting. The checking means 32 checks whether there are almost blank transmission subframes of said strongest interfering macro cell access node and active transmission subframes of said strongest interfering macro cell access node corresponding to active transmission subframes of a serving access node. If there are almost blank transmission subframes of said strongest interfering macro cell access node and active transmission subframes of said strongest interfering macro cell access node corresponding to active transmission subframes of said serving access node, the reporting means 33 reports said strongest interfering macro cell access node, and the receiving means 34 receives a transmission in a subframe, wherein a control parameter of said transmission is set based on whether said subframe corresponds to an almost blank transmission subframe of said strongest interfering macro cell access node or to an active transmission subframe of said strongest interfering macro cell access node. FIG. 8 is a schematic diagram of a procedure according to exemplary embodiments of the present invention. The apparatus according to FIG. 3 may perform the method of FIG. 8 but is not limited to this method. The method of FIG. 8 may be performed by the apparatus of FIG. 3 but is not limited to being performed by this apparatus.

As shown in FIG. 8, a procedure according to exemplary embodiments of the present invention comprises an operation of determining (S81) a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting, an operation of checking (S82) whether there are almost blank transmission subframes of said strongest interfering macro cell access node and active transmission subframes of said strongest interfering macro cell access node corresponding to active transmission subframes of a serving access node, and if there are almost blank transmission subframes of said strongest interfering macro cell access node and active transmission subframes of said strongest interfering macro cell access node corresponding to active transmission subframes of said serving access node (YES), an operation of reporting (S83) said strongest interfering macro cell access node, and an operation of receiving (S84) a transmission in a subframe, wherein a control parameter of said transmission is set based on whether said subframe corresponds to an almost blank transmission subframe of said strongest interfering macro cell access node or to an active transmission subframe of said strongest interfering macro cell access node.

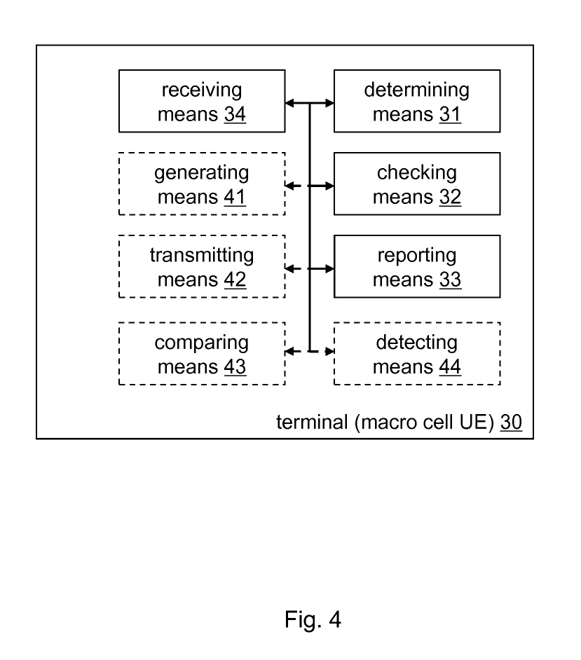

FIG. 4 is a block diagram illustrating an apparatus according to exemplary embodiments of the present invention. In particular, FIG. 4 illustrates a variation of the apparatus shown in FIG. 3. The apparatus according to FIG. 4 may thus further comprise generating means 41, transmitting means 42, comparing means 43, and detecting means 44.

According to a variation of the procedure shown in FIG. 8, exemplary additional operations are given, which are inherently independent from each other as such. According to such variation, an exemplary method according to exemplary embodiments of the present invention may comprise, if there are almost blank transmission subframes of said strongest interfering macro cell access node and active transmission subframes of said strongest interfering macro cell access node corresponding to active transmission subframes of said serving access node, an operation of generating a first channel quality indicator indicative of a reception quality regarding said serving access node during an almost blank transmission subframe of said strongest interfering macro cell access node, an operation of generating a second channel quality indicator indicative of a reception quality regarding said serving access node during an active transmission subframe of said strongest interfering macro cell access node, and an operation of transmitting said first and second channel quality indicators.

According to a variation of the procedure shown in FIG. 8, exemplary details of the checking operation are given, which are inherently independent from each other as such.

Such exemplary checking operation according to exemplary embodiments of the present invention may comprise an operation of comparing an almost blank transmission subframe ratio of said strongest interfering macro cell access node with an almost blank transmission subframe ratio of said serving access node, and/or an operation of detecting whether an almost blank transmission subframe pattern of said strongest interfering macro cell access node is not aligned with an almost blank transmission subframe pattern of said serving access node.

According to exemplary embodiments of the present invention, features regarding the setting of the control parameter and regarding the transmission may be similar as those discussed in relation to the method shown in FIG. 7.

Furthermore, according to exemplary embodiments of the present invention, features and a behavior of an access node in the scenario shown in FIG. 11 may be the same as those discussed in relation to an access node in the scenario shown in FIG. 10.

In the following, examples of concrete implementations of embodiments of the present inventions and comparison results thereof are given.

Namely, the enhanced PDCCH and PDSCH channel estimation schemes according to exemplary embodiments of the present invention were implemented in a (network) system simulator and compared to the baseline without the enhancements of the present invention. The primary difference in the two simulation sets were as follows:

### Baseline Simulations:

1) Data channel estimation only (no control channel modelling)
   a. Single PDSCH link adaptation loop for each Macro UE based on subframe status of serving cell
   b. Dual PDSCH link adaptation loop for each Pico UE based on subframe status of overlaying Macro eNB.
2) Data and Control Channel estimation
   a. Single PDSCH and PDCCH link adaptation loop for each Macro UE based on subframe status of serving cell
   b. Dual PDSCH and PDCCH link adaptation loop for each Pico UEs based on subframe status of overlaying Macro eNB.

### Enhanced Channel Estimation Simulations (According to the Present Invention):

1) Data channel estimation only (no control channel modelling)
   a. Dual PDSCH link adaptation loop for each Macro and Pico UE based on subframe status of strongest interfering Macro eNB
2) Data and Control Channel estimation
   a. Dual PDSCH and PDCCH link adaptation loop for each Macro and Pico UE based on subframe status of strongest interfering Macro eNB
      Benefit of Improved Data Channel Estimation with Full Buffer Traffic:
Performance benefits when using the improved data channel estimation technique according to exemplary embodiments of the present invention are shown in the table below. In these set of simulations, control channel was not modelled (i.e., no error in control channel)
Cell-edge (worst 5-percentile) UE throughput improves by 12.12% when enhanced data channel estimation techniques (according to exemplary embodiments of the present invention) are used, along with modest improvement geometric mean of UE throughput (2.55%). Note that the gain in cell-edge UE throughput does NOT come at the cost of sector throughput, which itself shows a small gain (1.01%).

Full Buffer Traffic

| | |
|---|---|
| Gain in Cell-edge UE throughput | 12.12% |
| Gain in Geometric Mean of UE | 2.55% |
| Throughput | |
| Gain in Average Macro Area | 1.01% |
| Throughput | |

Benefit of Improved Data Channel Estimation with FTP Traffic:
Performance benefits when using the improved data channel estimation technique according to exemplary embodiments of the present invention are shown in the table below. Traffic used in this case was 3^{rd} Generation Partnership Project (3GPP) file transfer protocol (FTP) Model 1, with 500 KByte files and an arrival rate of 5 users/sec, resulting in an average offered load of 20 mbps in each Macro area.
Cell-edge UE throughput improves by 10.51% with enhanced data channel estimation according to exemplary embodiments of the present invention along with a modest improvement in geometric mean of UE throughput (2.07%).

FTP Traffic (500 Kbyte Files arriving at 5 users/sec)

| | |
|---|---|
| Gain in cell-edge UE throughput | 10.51% |
| Gain in Geometric Mean of UE | 2.07% |
| Throughput | |
| Gain in Average Macro Area | 0.19% |
| Throughput | |

Benefit of Improved Data and Control Channel Estimation with FTP Traffic:
Performance benefits when using the improved data and control channel estimation technique according to exemplary embodiments of the present invention are shown in the table below. In these set of simulations, control channel error was also modelled.
Gain in cell-edge UE throughput improves by 25.01% using enhanced data and control channel estimation techniques according to exemplary embodiments of the present invention which is a factor of 2.5 times that when using just data channel estimation above. This is also accompanied by an increase in gain of the geometric mean of UE throughput (4.43%) without compromising on the average macro area throughput.

FTP Traffic (500 Kbyte Files arriving at 5 users/sec)

| | |
|---|---|
| Gain in cell-edge UE throughput | 25.01% |
| Gain in Geometric Mean of UE | 4.43% |
| Throughput | |
| Gain in Average Macro Area | 0.37% |
| Throughput | |

The above mentioned simulations were performed using a single CQI measurement of Macro UEs. Note that Pico UEs reported the 2 CQI values, one corresponding to the subframes where its top interfering Macro eNB was muted (ABS CQI), and the other in the presence of PDSCH transmissions from its top macro interferer (non-ABS CQI). Higher benefits are expected when the Macro UEs are also allowed to report dual CQIs according to exemplary embodiments of the present invention.

The above-described procedures and functions may be implemented by respective functional elements, processors, or the like, as described below.

In the foregoing exemplary description of the network entity, only the units that are relevant for understanding the principles of the invention have been described using functional blocks. The network entity may comprise further units that are necessary for its respective operation. However, a description of these units is omitted in this specification. The arrangement of the functional blocks of the devices is not construed to limit the invention, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

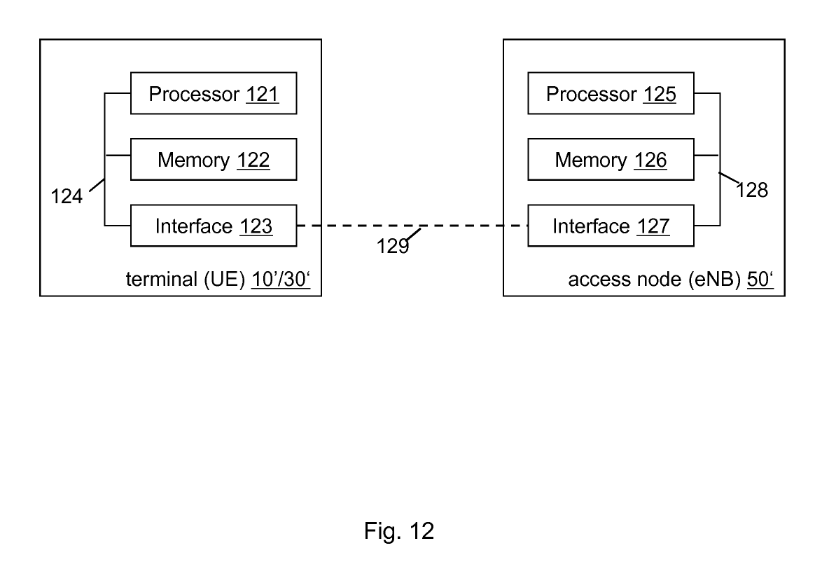

In FIG. 12, an alternative illustration of apparatuses according to exemplary embodiments of the present invention is depicted. As indicated in FIG. 12, according to exemplary embodiments of the present invention, the apparatus (Pico cell UE or Macro cell UE) 10730′ (corresponding to the Pico cell UE or Macro cell UE 10/30) comprises a processor 121, a memory 122 and an interface 123, which are connected by a bus 124 or the like. Further, according to exemplary embodiments of the present invention, the apparatus (eNB) 50′ (corresponding to the eNB 50) comprises a processor 125, a memory 126 and an interface 127, which are connected by a bus 128 or the like, and the apparatuses may be connected via link 129, respectively.

The processor 121/125 and/or the interface 123/127 may also include a modem or the like to facilitate communication over a (hardwire or wireless) link, respectively. The interface 123/127 may include a suitable transceiver coupled to one or more antennas or communication means for (hardwire or wireless) communications with the linked or connected device(s), respectively. The interface 123/127 is generally configured to communicate with at least one other apparatus, i.e. the interface thereof.

The memory 122/126 may store respective programs assumed to include program instructions or computer program code that, when executed by the respective processor, enables the respective electronic device or apparatus to operate in accordance with the exemplary embodiments of the present invention.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the terminal (Pico cell UE) 10 comprises at least one processor 121, at least one memory 122 including computer program code, and at least one interface 123 configured for communication with at least another apparatus. The processor (i.e. the at least one processor 121, with the at least one memory 122 and the computer program code) is configured to perform determining a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting (thus the apparatus comprising corresponding means for determining), to perform reporting said strongest interfering macro cell access node (thus the apparatus comprising corresponding means for reporting), and to perform receiving a transmission in a subframe, wherein a control parameter of said transmission is set based on whether said subframe corresponds to an almost blank transmission subframe of said strongest interfering macro cell access node or to an active transmission subframe of said strongest interfering macro cell access node (thus the apparatus comprising corresponding means for receiving).

Further, according to exemplary embodiments of the present invention, an apparatus representing the terminal (Macro cell UE) 30 comprises at least one processor 121, at least one memory 122 including computer program code, and at least one interface 123 configured for communication with at least another apparatus. The processor (i.e. the at least one processor 121, with the at least one memory 122 and the computer program code) is configured to perform determining a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting (thus the apparatus comprising corresponding means for determining), to perform checking whether there are almost blank transmission subframes of said strongest interfering macro cell access node and active transmission subframes of said strongest interfering macro cell access node corresponding to active transmission subframes of a serving access node (thus the apparatus comprising corresponding means for checking), and if there are almost blank transmission subframes of said strongest interfering macro cell access node and active transmission subframes of said strongest interfering macro cell access node corresponding to active transmission subframes of said serving access node, to perform reporting said strongest interfering macro cell access node (thus the apparatus comprising corresponding means for reporting), and to perform receiving a transmission in a subframe, wherein a control parameter of said transmission is set based on whether said subframe corresponds to an almost blank transmission subframe of said strongest interfering macro cell access node or to an active transmission subframe of said strongest interfering macro cell access node (thus the apparatus comprising corresponding means for receiving).

Furthermore, according to exemplary embodiments of the present invention, an apparatus representing the access node (eNB) 50 comprises at least one processor 125, at least one memory 126 including computer program code, and at least one interface 127 configured for communication with at least another apparatus. The processor (i.e. the at least one processor 125, with the at least one memory 126 and the computer program code) is configured to perform obtaining a strongest interfering macro cell access node of a terminal, said strongest interfering macro cell access node operating in time based subframes, wherein said subframes comprise almost blank transmission subframes during which said strongest interfering macro cell access node is muted and active transmission subframes during which said strongest interfering macro cell access node is transmitting (thus the apparatus comprising corresponding means for obtaining), and to perform setting a control parameter of a transmission scheduled for a subframe based on whether said subframe corresponds to an almost blank transmission subframe of said strongest interfering macro cell access node or to an active transmission subframe of said strongest interfering macro cell access node (thus the apparatus comprising corresponding means for setting).

For further details regarding the operability/functionality of the individual apparatuses, reference is made to the above description in connection with any one of FIGS. 1 to 11, respectively.

For the purpose of the present invention as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for inter-cell interference coordination in heterogeneous networks. Such measures exemplarily comprise determining a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting, reporting said strongest interfering macro cell access node, and receiving a transmission in a subframe, wherein a control parameter of said transmission is set based on whether said subframe corresponds to an almost blank transmission subframe of said strongest interfering macro cell access node or to an active transmission subframe of said strongest interfering macro cell access node.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

List of acronyms and abbreviations
3GPP 3^{rd} Generation Partnership Project
ABS Almost Blank Subframes
CCE control channel element
CQI channel quality indicator
eICIC Enhanced Inter-Cell Interference Coordination
eNB evolved NodeB, eNodeB
FTP file transfer protocol
HetNet heterogeneous network
LTE Long Term Evolution
MCS modulation and coding scheme
OPNET Optimized Network Engineering Tools
PDCCH physical downlink control channel
PDSCH physical downlink shared channel
RSRP reference signal received power
SINR signal to interference and noise ratio
SNR signal to noise ratio
UE user equipment

1. A method comprising
determining a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting,
reporting said strongest interfering macro cell access node, and
receiving a transmission in a subframe, wherein a control parameter of said transmission is set based on whether said subframe corresponds to an almost blank transmission subframe of said strongest interfering macro cell access node or to an active transmission subframe of said strongest interfering macro cell access node.

2. The method according to claim 1, further comprising
generating a first channel quality indicator indicative of a reception quality regarding a serving access node during an almost blank transmission subframe of said strongest interfering macro cell access node,
generating a second channel quality indicator indicative of a reception quality regarding said serving access node during an active transmission subframe of said strongest interfering macro cell access node, and
transmitting said first and second channel quality indicators wherein optionally
said control parameter is set based on said first channel quality indicator, if said subframe corresponds to an almost blank transmission subframe of said strongest interfering macro cell access node, and
said control parameter is set based on said second channel quality indicator, if said subframe corresponds to an active transmission subframe of said strongest interfering macro cell access node.

3. (canceled)

4. The method according to claim 1, wherein
said transmission comprises a physical downlink shared channel, and
said control parameter is a modulation and coding scheme which is set higher if said subframe corresponds to an almost blank transmission subframe of said strongest interfering macro cell access node than if said subframe corresponds to an active transmission subframe of said strongest interfering macro cell access node, and/or
said control parameter is a scheduling metric which is set higher if said subframe corresponds to an almost blank transmission subframe of said strongest interfering macro cell access node than if said subframe corresponds to an active transmission subframe of said strongest interfering macro cell access node.

5. The method according to claim 1, wherein
said transmission comprises a physical downlink control channel, and
said control parameter is a number of used control channel elements which is set lower if said subframe corresponds to an almost blank transmission subframe of said strongest interfering macro cell access node than if said subframe corresponds to an active transmission subframe of said strongest interfering macro cell access node, and/or
said control parameter is a transmission power which is set lower if said subframe corresponds to an almost blank transmission subframe of said strongest interfering macro cell access node than if said subframe corresponds to an active transmission subframe of said strongest interfering macro cell access node.

6. A method comprising
determining a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting,
checking whether there are almost blank transmission subframes of said strongest interfering macro cell access node and active transmission subframes of said strongest interfering macro cell access node corresponding to active transmission subframes of a serving access node, wherein
if there are almost blank transmission subframes of said strongest interfering macro cell access node and active transmission subframes of said strongest interfering macro cell access node corresponding to active transmission subframes of said serving access node, said method further comprises
reporting said strongest interfering macro cell access node, and
receiving a transmission in a subframe, wherein a control parameter of said transmission is set based on whether said subframe corresponds to an almost blank transmission subframe of said strongest interfering macro cell access node or to an active transmission subframe of said strongest interfering macro cell access node.

7. The method according to claim 6,
if there are almost blank transmission subframes of said strongest interfering macro cell access node and active transmission subframes of said strongest interfering macro cell access node corresponding to active transmission subframes of said serving access node, said method further comprises
generating a first channel quality indicator indicative of a reception quality regarding said serving access node during an almost blank transmission subframe of said strongest interfering macro cell access node,
generating a second channel quality indicator indicative of a reception quality regarding said serving access node during an active transmission subframe of said strongest interfering macro cell access node, and
transmitting said first and second channel quality indicators.

8. The method according to claim 6 or 7, wherein
in relation to said checking, said method further comprises
comparing an almost blank transmission subframe ratio of said strongest interfering macro cell access node with an almost blank transmission subframe ratio of said serving access node, and/or
detecting whether an almost blank transmission subframe pattern of said strongest interfering macro cell access node is not aligned with an almost blank transmission subframe pattern of said serving access node.

9-14. (canceled)

15. An apparatus comprising
at least one processor,
at least one memory including computer program code, and
at least one interface configured for communication with at least another apparatus,
the at least one processor, with the at least one memory and the computer program code, being configured to cause the apparatus to perform:
determining a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting,
reporting said strongest interfering macro cell access node, and
receiving a transmission in a subframe, wherein a control parameter of said transmission is set based on whether said subframe corresponds to an almost blank transmission subframe of said strongest interfering macro cell access node or to an active transmission subframe of said strongest interfering macro cell access node.

16. The apparatus according to claim 15, wherein
the at least one processor, with the at least one memory and the computer program code, being configured to cause the apparatus to perform:
generating a first channel quality indicator indicative of a reception quality regarding a serving access node during an almost blank transmission subframe of said strongest interfering macro cell access node,
generating a second channel quality indicator indicative of a reception quality regarding said serving access node during an active transmission subframe of said strongest interfering macro cell access node, and
transmitting said first and second channel quality indicators, wherein optionally
said control parameter is set based on said first channel quality indicator, if said subframe corresponds to an almost blank transmission subframe of said strongest interfering macro cell access node, and
said control parameter is set based on said second channel quality indicator, if said subframe corresponds to an active transmission subframe of said strongest interfering macro cell access node.

17. (canceled)

18. The apparatus according to claim 15, wherein
said transmission comprises a physical downlink shared channel, and
said control parameter is a modulation and coding scheme which is set higher if said subframe corresponds to an almost blank transmission subframe of said strongest interfering macro cell access node than if said subframe corresponds to an active transmission subframe of said strongest interfering macro cell access node, and/or
said control parameter is a scheduling metric which is set higher if said subframe corresponds to an almost blank transmission subframe of said strongest interfering macro cell access node than if said subframe corresponds to an active transmission subframe of said strongest interfering macro cell access node.

19. The apparatus according to claim 15, wherein
said transmission comprises a physical downlink control channel, and
said control parameter is a number of used control channel elements which is set lower if said subframe corresponds to an almost blank transmission subframe of said strongest interfering macro cell access node than if said subframe corresponds to an active transmission subframe of said strongest interfering macro cell access node, and/or
said control parameter is a transmission power which is set lower if said subframe corresponds to an almost blank transmission subframe of said strongest interfering macro cell access node than if said subframe corresponds to an active transmission subframe of said strongest interfering macro cell access node.

20. The apparatus according to claim 15, wherein
the apparatus is operable as or at a terminal, user equipment, mobile station or modem, and/or
the apparatus is operable in at least one of a LTE and a LTE-A cellular system.

21. An apparatus comprising
at least one processor,
at least one memory including computer program code, and
at least one interface configured for communication with a least another apparatus,
the at least one processor, with the at least one memory and the computer program code, being configured to cause the apparatus to perform:
determining a strongest interfering macro cell access node, said strongest interfering macro cell access node operating in time based subframes, wherein said subframes comprise almost blank transmission subframes during which said strongest interfering macro cell access node is muted and active transmission subframes during which said strongest interfering macro cell access node is transmitting,
checking whether there are almost blank transmission subframes of said strongest interfering macro cell access node and active transmission subframes of said strongest interfering macro cell access node corresponding to active transmission subframes of a serving access node, and
if there are almost blank transmission subframes of said strongest interfering macro cell access node and active transmission subframes of said strongest interfering macro cell access node corresponding to active transmission subframes of said serving access node,
reporting said strongest interfering macro cell access node, and
receiving a transmission in a subframe, wherein a control parameter of said transmission is set based on whether said subframe corresponds to an almost blank transmission subframe of said strongest interfering macro cell access node or to an active transmission subframe of said strongest interfering macro cell access node.

22. The apparatus according to claim 21,
wherein
the at least one processor, with the at least one memory and the computer program code, being configured to cause the apparatus to perform:
if there are almost blank transmission subframes of said strongest interfering macro cell access node and active transmission subframes of said strongest interfering macro cell access node corresponding to active transmission subframes of said serving access node,
generating a first channel quality indicator indicative of a reception quality regarding said serving access node during an almost blank transmission subframe of said strongest interfering macro cell access node, and to
generating a second channel quality indicator indicative of a reception quality regarding said serving access node during an active transmission subframe of said strongest interfering macro cell access node, and
transmitting transmit said first and second channel quality indicators.

23. The apparatus according to claim 21,
wherein
the at least one processor, with the at least one memory and the computer program code, being configured to cause the apparatus to perform:
comparing an almost blank transmission subframe ratio of said strongest interfering macro cell access node with an almost blank transmission subframe ratio of said serving access node, and/or
detecting whether an almost blank transmission subframe pattern of said strongest interfering macro cell access node is not aligned with an almost blank transmission subframe pattern of said serving access node.

24. The apparatus according to claim 21, wherein
the apparatus is operable as or at a terminal, user equipment, mobile station or modem, and/or
the apparatus is operable in at least one of a LTE and a LTE-A cellular system.

25.-31. (canceled)

32. A computer program product comprising a non-transitory computer-readable medium on which computer-executable computer program code is stored which, when the program is run on a computer, is configured to cause the computer to carry out a method according to claim 1.

33. (canceled)

34. A computer program product comprising a non-transitory computer-readable medium on which computer-executable computer program code is stored which, when the program is run on a computer, is configured to cause the computer to carry out a method according to claim 6.
